(19) United States
(12) Patent Application Publication
(10) Pub. No.: US 2024/0039881 A1
(43) Pub. Date: Feb. 1, 2024

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Takaki TSUCHIYA, Kanagawa (JP)

(73) Assignee: FUJIFILM Business Innovation Corp., Tokyo (JP)

(21) Appl. No.: 18/188,471

(22) Filed: Mar. 23, 2023

(30) Foreign Application Priority Data
Jul. 27, 2022 (JP) 2022-119425

(51) Int. Cl. H04L 51/224

(52) U.S. Cl. CPC H04L 51/224

(57) ABSTRACT

An information processing apparatus includes a processor, in which the processor is configured to specify, in a case where information for specifying data of interest is contributed to a channel that is a place where plural users are able to contribute information via a communication line or in a case where the information for specifying the data of interest is input for contribution to the channel, a notification target user based on data-related information including at least one of an operation history indicating a user who performs an operation with respect to the data of interest previously or attribute information indicating a user registered as an attribute of the data of interest, and perform notification to the notification target user after the information for specifying the data of interest is contributed.

### CROSS-REFERENCE TO RELATED APPLICATIONS

This application is based on and claims priority under 35 USC 119 from Japanese Patent Application No. 2022-119425 filed Jul. 27, 2022.

### BACKGROUND

### (i) Technical Field

The present invention relates to an information processing apparatus, a non-transitory computer readable medium storing an information processing program, and an information processing method.

### (ii) Related Art

Hitherto, a technique that, in a case where an operation is performed with respect to data, performs notification to a user related to the data has been suggested.

For example, JP5716400B discloses an information processing apparatus that records an operation type, an operator, and operation date and time as a history of an operation regarding an electronic document, and in a case where any operation is performed with respect to the electronic document, performs notification to a user who registers the electronic document or a user who performs an operation with respect to the electronic document within a predetermined period. JP6852373B discloses an information processing apparatus that, in a case where an electronic document is newly registered with respect to a specific folder or in a case where an electronic document stored in the folder is updated, performs notification to a user based on importance of the electronic document or importance of a registrant of the electronic document.

### SUMMARY

By the way, hitherto, a communication tool that is software for allowing a plurality of users to communicate via a communication line is provided. In such a communication tool, a channel that is a place where a plurality of users can contribute information (for example, a message) via the communication line is prepared, and a plurality of users who are participating in the channel (are registered in advance) can contribute information to the channel. Information for specifying data (for example, a link to a storage location of the data or the data) can also be contributed, and as a result, a user can send the data to another user who is participating in the channel.

Hitherto, the communication tool is provided with a notification function. Such a notification function may also be referred to as a mentioning function. The user selects notification target users, and then, contributes information to the channel, whereby the user can notify the notification target users that information is contributed to the channel.

Here, a case where a certain user contributes information for specifying data of interest to the channel and notifies another user that the information is contributed is considered. In this case, it is desirable that the user performs notification only to, for example, users who are related to the data of interest. All users who are participating in the channel may include users who are not related to the data of interest, and it may not be appropriate to perform notification to the unrelated users. In a case of individually selecting the notification target users, the user who contributes the information for specifying the data of interest may not know users who are related to the data of interest, and even though the users who are related to the data of interest are known, the processing of individually designating the notification target users may be complicated.

Aspects of non-limiting embodiments of the present disclosure relate to an information processing apparatus, a non-transitory computer readable medium storing an information processing program, and an information processing method that, in a case where information for specifying data of interest is contributed to a channel of a communication tool, perform notification only to users who are related to the data of interest.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor, in which the processor is configured to specify, in a case where information for specifying data of interest is contributed to a channel that is a place where a plurality of users are able to contribute information via a communication line or in a case where the information for specifying the data of interest is input for contribution to the channel, a notification target user based on data-related information including at least one of an operation history indicating a user who performs an operation with respect to the data of interest previously or attribute information indicating a user registered as an attribute of the data of interest, and perform notification to the notification target user after the information for specifying the data of interest is contributed.

### BRIEF DESCRIPTION OF THE DRAWINGS

Exemplary embodiment(s) of the present invention will be described in detail based on the following figures, wherein:

FIG. 1 is a schematic configuration diagram of an information processing system according to a present exemplary embodiment;

FIG. 2 is a schematic configuration diagram of a data management server;

FIG. 3 is a conceptual diagram showing an example of contents of a data management DB;

FIG. 4 is a conceptual diagram showing an example of contents of an operation history DB;

FIG. 5 is a schematic configuration diagram of a communication tool providing server;

FIG. 6 is a diagram showing an example of a screen of a communication tool;

FIG. 7 is a conceptual diagram showing an example of contents of a channel DB;

FIG. 8 is a conceptual diagram showing an example of contents of a message DB;

FIG. 9 is a first diagram showing a creation example of a message with a notification instruction;

FIG. 10 is a second diagram showing a creation example of a message with a notification instruction;

FIG. 11 is a first diagram showing a notification example of notifying that there is no notification target user;

FIG. 12 is a first diagram showing a notification example of a notification target user;

FIG. 13 is a first diagram showing a notification example of the number of users corresponding to each specifying condition;

FIG. 14 is a second diagram showing a notification example of a notification target user;

FIG. 15 is a diagram showing an input example of a case where a link to data is included in a message with a notification instruction;

FIG. 16 is a second diagram showing a notification example of notifying that there is no notification target user;

FIG. 17 is a third diagram showing a notification example of a notification target user;

FIG. 18 is a second diagram showing a notification example of the number of users corresponding to each specifying condition; and

FIG. 19 is a flowchart showing a flow of processing of a communication tool providing server according to the present exemplary embodiment.

### DETAILED DESCRIPTION

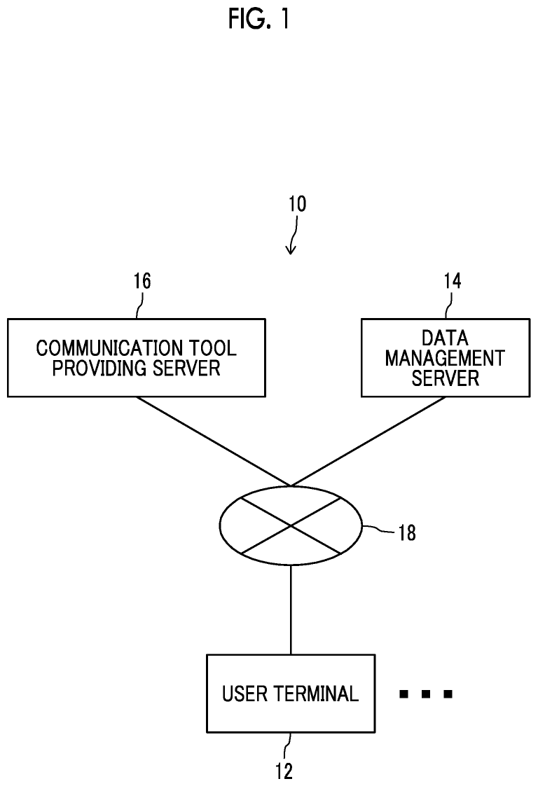

FIG. 1 is a schematic configuration diagram of an information processing system 10 according to a present exemplary embodiment. The information processing system 10 includes a plurality of user terminals 12, a data management server 14, and a communication tool providing server 16 as an information processing apparatus. The plurality of user terminals 12, the data management server 14, and the communication tool providing server 16 are connected to be communicable with each other via a communication line 18 including a local area network (LAN), a wide area network (WAN), or the like.

The user terminal 12 is an apparatus that is used by a user (a user of a data management service that is provided by the data management server 14 and a communication tool that is provided by the communication tool providing server 16). The user terminal 12 is, for example, a computer, such as a personal computer, a tablet terminal, or a smartphone, but is not limited thereto. The user terminal 12 includes a communication interface for communicating with the data management server 14 and the communication tool providing server 16 via the communication line 18, an input interface for receiving a command of a user, a display that displays a screen of the communication tool, or the like, a memory for storing data, a processor that executes respective processing, and the like.

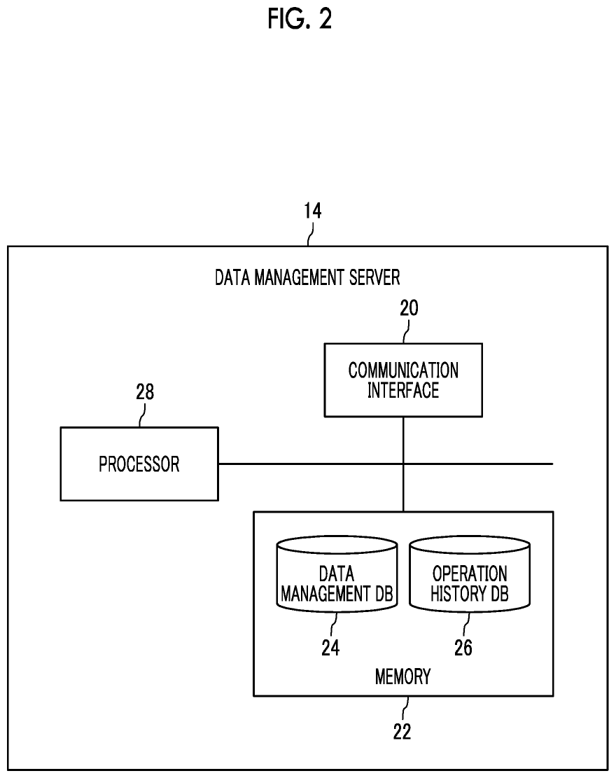

FIG. 2 is a schematic configuration diagram of the data management server 14. The data management server 14 is configured with, for example, a server computer. The data management server 14 may be configured with one computer or may be configured by cooperation of a plurality of computers.

The data management server 14 provides a data management service to a user who finishes user registration. The data management service is a service that stores and manages data (electronic data) received from the user in a database, and executes processing or the like of providing data under management to the user in response to a request from the user. While data is representatively an electronic document, data is not limited to the electronic document, but may be, for example, image data, music data, or program data.

A communication interface 20 is configured with a network interface card (NIC) or the like. The communication interface 20 exhibits a function of communicating the user terminal 12 or the communication tool providing server 16 via the communication line 18.

A memory 22 includes a hard disk drive (HDD), a solid state drive (SSD), an embedded multimedia card (eMMC), a read only memory (ROM) or a random access memory (RAM). As shown in FIG. 2, a data management database (DB) 24 and an operation history DB 26 are stored in the memory 22. Though not shown in FIG. 2, in the memory 22, a user DB in which a user ID for uniquely identifying a registered user, a user name of the user, authentication information (for example, a password), and the like are associated is stored.

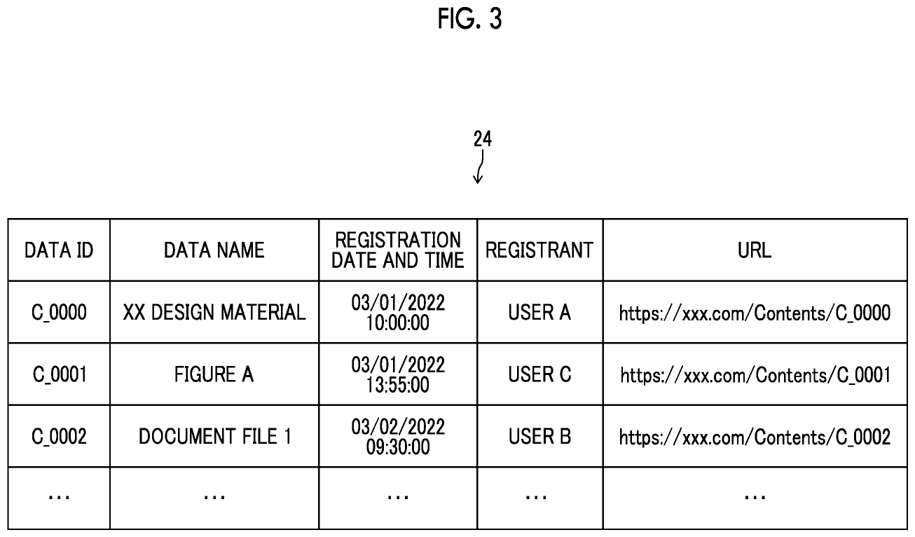

The data management DB 24 is a database in which data uploaded from the user and attribute information of data are stored. FIG. 3 is a diagram showing an example of contents of the data management DB 24. In the data management DB 24, in addition to data, as the attribute information of data, a data ID for uniquely identifying data, registration date and time that is date and time on which the data is registered in the data management service, a user ID of a user (registrant) who registers the data in the data management service, and a uniform resource locator (URL) indicating a storage location of the data are stored in association with one another. In a case where data is received from a user who logs in to the data management service, a processor 28 described below registers the data and the attribute information of the data in the data management DB 24.

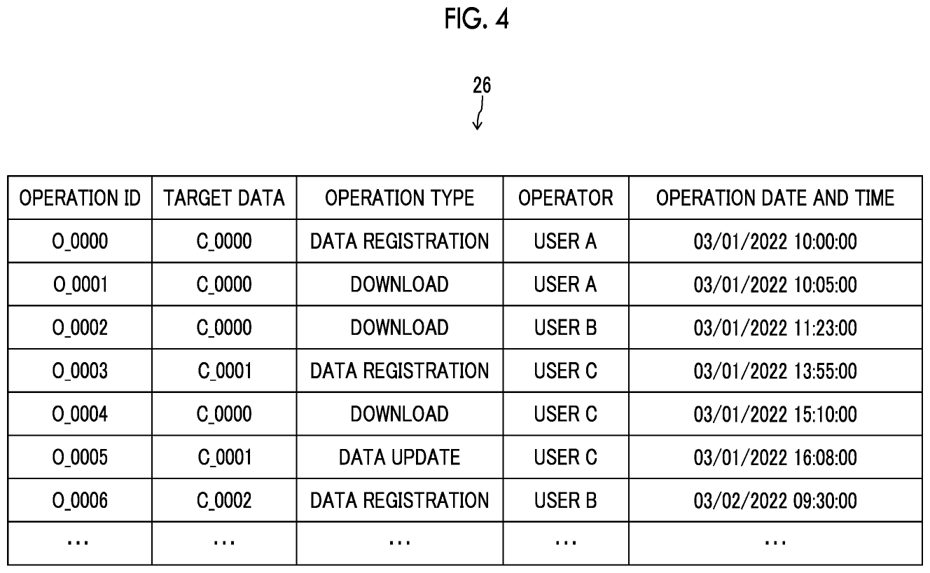

The operation history DB 26 is a database in which history information indicating an operation history of the user with respect to the data registered in the data management service is stored. FIG. 4 is a diagram showing an example of contents of the operation history DB 26. In the operation history DB 26, as the history information, an operation ID for uniquely identifying an operation performed by the user, a data ID of target data that is data to be a target of the operation, an operation type (for example, registration, reading (download), and update) of the operation, a user ID of a user (operator) who performs the operation, and operation date and time that is date and time on which the operation is performed are stored in association with one another. In a case where the user performs an operation with respect to data registered in the data management service (or data that is registered in future), the processor 28 described below registers the history information indicating the operation history in the operation history DB 26.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed. The processor 28 controls each unit of the data management server 14.

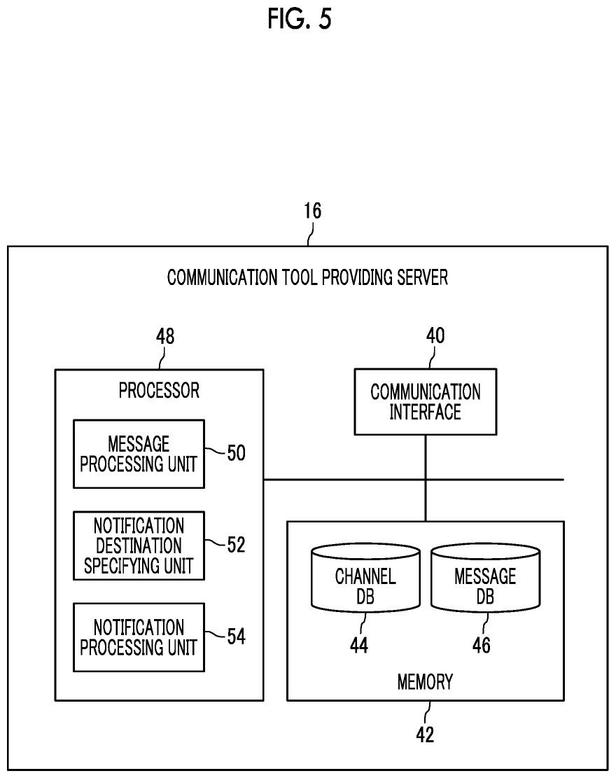

FIG. 5 is a schematic configuration diagram of the communication tool providing server 16. Similarly to the data management server 14, the communication tool providing server 16 is configured with, for example, a server computer. The communication tool providing server 16 may be configured with one computer or may be configured by cooperation of a plurality of computers. The communication tool providing server 16 may be integrated with the above-described data management server 14. That is, the communication tool providing server 16 may exhibit the functions of the data management server 14, and the communication tool providing server 16 may provide the data management service to the user.

The communication tool providing server 16 provides a communication tool to a user who finishes user registration. The communication tool provides a “place” where a plurality of users can contribute information via the communication line 18, to a plurality of users. In the present specification, such a “place” is referred to as a channel. A user of the communication tool can create the channel. The user who creates the channel can register other users who will participate in the channel. The users who participate in the channel may be able to register other users in the channel. In this manner, a plurality of users participate in the channel created by the user.

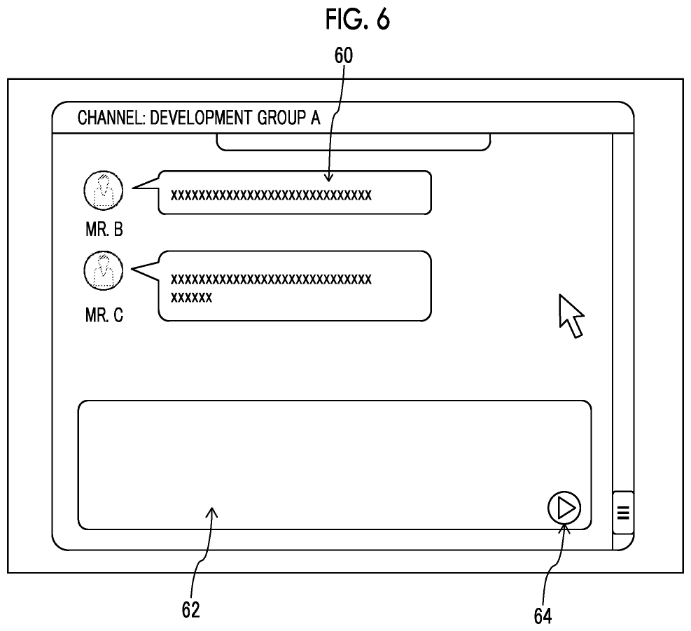

FIG. 6 is a diagram showing an example of a screen displayed on a display of the user terminal 12, provided from the communication tool. In a case where a user (in this case, referred to as “Mr. A”) of the communication tool accesses the communication tool using the user terminal 12 and selects a channel (in this case, a channel called “development group A”) in which the user participates, the screen (hereinafter, referred to as a “channel screen”) shown in FIG. 6 is displayed on the display of the user terminal 12 of Mr. A. On the channel screen, messages 60 as information that is contributed to the channel by users (in this case, including Mr. A, Mr. B, and Mr. C) who are participating in the channel are displayed. Since only the users who are participating in the channel can access the channel, a user who does not participate in the channel cannot view the messages 60 contributed to the channel.

The channel screen includes an input field 62 to which the user (in this case, Mr. A) inputs the content of the message 60 contributed to the channel. In a case where the user inputs some content to the input field 62 and operates a transmission button 64, the message 60 of the content input to the input field 62 is contributed to the channel. With this, the users who are participating in the channel can read the contributed message 60.

Each user can contribute information for specifying data, in particular, data managed by the data management server 14 as the message 60 to the channel. For example, a URL (see FIG. 3) where data managed by the data management server 14 is stored or data managed by the data management server 14 can be contributed as the message 60. With this, the user can send the data to other users who are participating in the channel.

Even though the user contributes the message 60 to the channel, excluding a case where a message with a notification instruction described below is contributed, the users who are participating in the channel are not notified that the message 60 is contributed. Basically, the users who are participating in the channel confirm (read) the message 60 contributed to the channel by voluntarily accessing the channel.

Returning to FIG. 5, a communication interface 40 is configured with a NIC or the like. The communication interface 40 exhibits a function of communicating with the user terminal 12 or the data management server 14 via the communication line 18.

The memory 42 includes an HDD, an SSD, an eMMC, a ROM, a RAM, or the like. In the memory 42, an information processing program for operating each unit of the communication tool providing server 16 is stored. The information processing program can also be stored in a non-transitory computer readable storage medium, such as a universal serial bus (USB) memory or a CD-ROM. The communication tool providing server 16 can read the information processing program from such a storage medium and execute the information processing program.

Though not shown in FIG. 5, in the memory 42, a user DB in which the user ID for uniquely identifying the user registered as the user of the communication tool, authentication information (for example, password), and the like are associated with one another is stored. In the present exemplary embodiment, user information (user ID, user name, authentication information, and the like) is shared between the data management service and the communication tool. In a case where the user information is not shared between the data management service and the communication tool, user mapping information indicating correspondence between the user information of the data management service and the user information of the communication tool is prepared in advance, and is stored in a memory (for example, the memory 42) to which the communication tool providing server 16 can access.

As shown in FIG. 5, a channel DB 44 and a message DB 46 are stored in the memory 42.

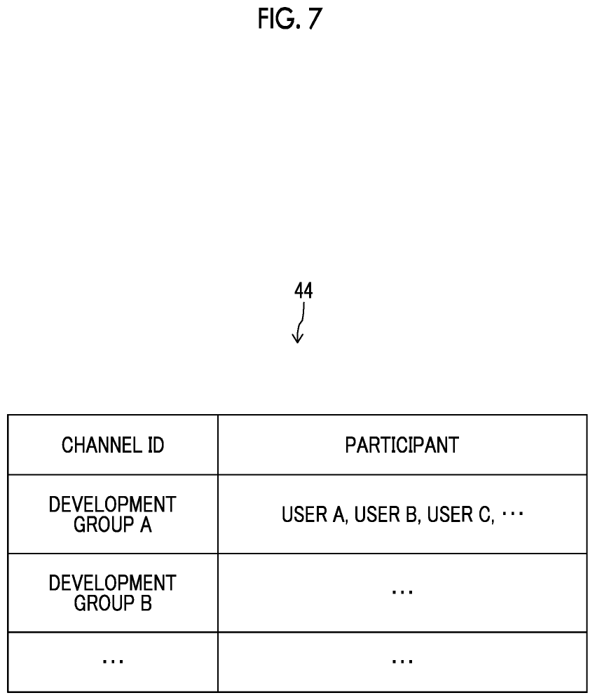

The channel DB 44 is a database in which the channel created by the user in the communication tool and the users who are participating in the channel are stored. FIG. 7 is a diagram showing an example of contents of the channel DB 44. In the channel DB 44, a channel ID for uniquely identifying a channel and a user ID of a user who is participating in the channel are stored in association with each other. In a case where a channel is created in the communication tool or in a case where a new user is registered in a created channel, a processor 48 (in particular, a message processing unit 50) described below registers the channel ID or the user ID in the channel DB 44.

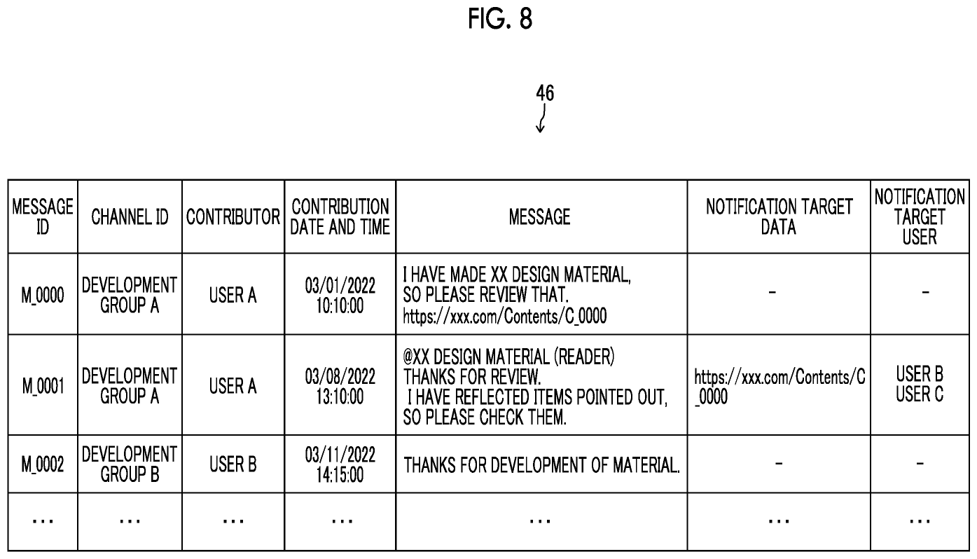

The message DB 46 is a database in which a message contributed to the channel created by the user in the communication tool and attribute information regarding the message are stored. FIG. 8 is a diagram showing an example of contents of the message DB 46. In the message DB 46, in addition to a message, a message ID for uniquely identifying the message, a channel ID for uniquely identifying a channel to which the message is contributed, a user ID of a user (contributor) who contributes the message, and contribution date and time that is date and time on which the message is contributed are stored as attribute information of the message in association with one another. The notification target data and the notification target user will be described below. In a case where contribution of a message is received from a user who logs in to the communication tool, the processor 48 (in particular, the message processing unit 50) registers the message and the attribute information of the message in the message DB 46.

Returning to FIG. 5, in the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed. As shown in FIG. 5, the processor 48 exhibits functions as a message processing unit 50, a notification destination specifying unit 52, and a notification processing unit 54 by the information processing program stored in the memory 42.

The message processing unit 50 executes basic processing regarding the communication tool. Specifically, the message processing unit 50 executes processing of creating a channel in response to an instruction from a user who logs in to the communication tool, processing of registering a user who will participate in the channel, processing of displaying a screen (see FIG. 6) regarding the communication tool on the display of the user terminal 12, and processing of contributing a message to the channel in response to an instruction from the user terminal 12.

As described above, in the communication tool, normally, even though a user contributes a message to the channel, notification is not performed to the users who are participating in the channel. However, in the communication tool according to the present exemplary embodiment, the user can contribute a message with a notification instruction to the channel. In a case where a message with a notification instruction is contributed to the channel, the processor 48 notifies the users who are participating in the channel that the message with notification instruction is contributed.

In the present exemplary embodiment, in a case where the message with a notification instruction is contributed to the channel, the processor 48 can perform notification only to a part of the users who are participating in the channel, not all the users who are participating in the channel. In particular, in a case where information (in the present exemplary embodiment, a message) for specifying data managed by the data management server 14 is contributed to the channel, the processor 48 may perform notification only to users who are related to the data, among the users who are participating in the channel. Such a function is realized by the notification destination specifying unit 52 and the notification processing unit 54. Hereinafter, the details of the notification destination specifying unit 52 and the notification processing unit 54 will be described.

The notification destination specifying unit 52 specifies a notification target user that is a user of a notification destination in a case where a message with notification instruction for specifying data managed by the data management server 14 is contributed. As described above, the notification target user specified by the notification destination specifying unit 52 is a user who is related to data specified by the message with a notification instruction.

In detail, in a case where a message (in the present specification, specified data is referred to as “data of interest”) for specifying data managed by the data management server 14 is contributed to the channel or in a case where a message for specifying the data of interest is input to the input field 62 (see FIG. 6) for contribution to the channel, the notification destination specifying unit 52 specifies a user who is related to the data of interest, as the notification target user. In the present specification, the channel to which the data of interest is contributed or to which the data of interest is about to be contributed (the channel corresponding to the input field 62 to which information for specifying the data of interest is input) is referred to as a channel of interest. Here, the message for specifying the data of interest is, for example, a message including a URL indicating the storage location of the data of interest or a message attached with the data of interest.

The notification destination specifying unit 52 specifies a user who is related to the data of interest, based on data-related information that is information stored in at least one of the data management DB 24 or the operation history DB 26 stored in the memory 22 of the data management server 14.

Specifically, the notification destination specifying unit 52 sends the URL or the data ID of the data of interest to the data management server 14. The processor 28 of the data management server 14 searches the data management DB 24 (see FIG. 3) with the received URL of the data of interest as a key, and specifies a user ID of a user (in the present exemplary embodiment, registrant) who is related to the received URL or data ID of the data of interest (that is, registered as the attribute of the data of interest). The processor 28 transmits the specified user ID to the communication tool providing server 16. With this, the notification destination specifying unit 52 can specify the registrant of the data of interest as the notification target user.

The processor 28 of the data management server 14 specifies the data ID of the data of interest based on the received URL of the data of interest and the data management DB 24, searches the operation history DB 26 (see FIG. 4) with the specified data ID (in a case where the data ID is received, the received data ID) as a key, and specifies a user ID of a user (operator, that is, a user who performs an operation with respect to the data of interest previously) who is related to the data ID of the data of interest. The processor 28 transmits the specified user ID to the communication tool providing server 16. With this, the notification destination specifying unit 52 can specify the user who performs an operation with respect to the data of interest previously, as the notification target user.

The notification destination specifying unit 52 may set a user who performs an operation of a specific operation type with respect to the data of interest, as the notification target user. For example, in a case of setting only a user who performs an update operation with respect to the data of interest, as the notification target user, the notification destination specifying unit 52 sends information indicating a specifying condition (update operation) of the notification target user to the data management server 14 along with the URL or the data ID of the data of interest. The processor 28 of the data management server 14 searches the operation history DB 26 with the data ID of the data of interest as a key, and specifies a user ID of a user who is related to the data ID of the data of interest and performs an operation of an operation type “data update”. The processor 28 transmits the specified user ID to the communication tool providing server 16. With this, the notification destination specifying unit 52 can specify a user who performs data update with respect to the data of interest previously, as the notification target user. In the same manner, the notification destination specifying unit 52 can specify a user who reads the data of interest previously (a user who “downloads” the data of interest), as the notification target user.

The contents of the operation history DB 26 are accumulated each time each user performs an operation with respect to data. That is, the contents of the operation history DB 26 are dynamically changed. Accordingly, in a case where the notification destination specifying unit 52 specifies the notification target user based on the operation history DB 26, the notification target user is also dynamically changed with the accumulation of the operation history in the operation history DB.

In the present exemplary embodiment, the notification destination specifying unit 52 specifies the notification target user from a plurality of users who are participating in the channel of interest (that is, users who can read information contributed to the channel of interest). Specifically, the notification destination specifying unit 52 sets only users indicated by user IDs related to the channel ID of the channel of interest among a plurality of user IDs received from the data management server 14 as the notification target user based on the channel DB 44 (see FIG. 7), and excludes users indicated by user IDs not related to the channel ID of the channel of interest from the notification target user.

The notification destination specifying unit 52 may set a user who does not perform an operation of a specific operation type with respect to the data of interest, among a plurality of users who are participating in the channel of interest, as the notification target user. For example, a user who does not read the data of interest, among a plurality of users who are participating in the channel of interest can also be set as the notification target user. In this case, the notification destination specifying unit 52 receives user IDs of users who read the data of interest previously, from the data management server 14, and sets users indicated by user IDs other than the received user IDs among a plurality of user IDs related to the channel of interest in the channel DB 44 as the notification target user.

For example, a user (in the present specification, referred to as a “user of interest”) who contributes a message for specifying the data of interest to the channel of interest or inputs information for specifying the data of interest to the input field 62 corresponding to the channel of interest for contribution to the channel of interest may be able to designate a specifying condition for specifying the notification target user. Here, the specifying condition is a condition regarding the data-related information (as described above, information stored in at least one of the data management DB 24 or the operation history DB 26). The notification destination specifying unit 52 specifies a user who satisfies the specifying condition received from the user of interest, as the notification target user.

For example, the user of interest can designate a registrant of the data of interest in the data management server 14, as the specifying condition. In this case, the notification destination specifying unit 52 specifies the registrant of the data of interest in the data management server 14 as the notification target user in response to an instruction from the user of interest. Besides, the user of interest can designate, for example, a condition, such as a user who updates the data of interest, a reader of the data of interest, or an un-reader of the data of interest among the users who are participating in the channel of interest, as the specifying condition.

The notification processing unit 54 performs notification to the notification target user specified by the notification destination specifying unit 52 after the message for specifying the data of interest is contributed to the channel of interest. Although any method may be used as a method of notification, for example, the notification processing unit 54 displays a message or an icon for notification on the display of the user terminal 12 that is used by the notification target user.

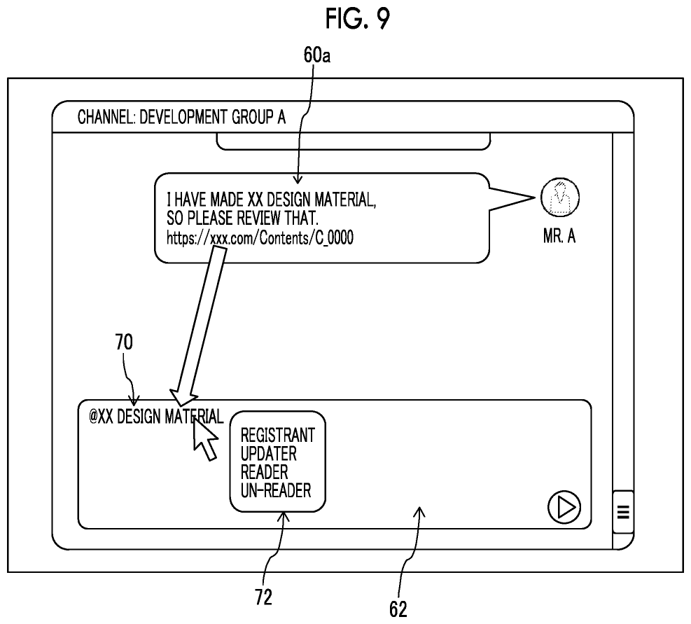

Hereinafter, a specific example of processing of the message processing unit 50, the notification destination specifying unit 52, and the notification processing unit 54 will be described referring to a screen of the communication tool shown in FIGS. 9 to 16.

FIGS. 9 to 16 show a screen of the communication tool (in particular, a screen on which the channel of interest is displayed) displayed on the display of the user terminal 12 that is used by the user of interest. In the following example, it is assumed that the user of interest is “Mr. A”.

FIG. 9 is a diagram showing a state in which a message 60a for specifying data of interest, specifically, the message 60a including a URL (https://xxx.com/Contents/C_0000) indicating a storage location of the data of interest is already contributed to a channel of interest by Mr. A. Since the message 60a is not a message with a notification instruction, even though the message 60a is contributed to the channel of interest, notification is not performed to participants of the channel of interest.

Accordingly, the user of interest designates the data of interest in the input field 62 to notify the user of the channel of interest that a link of the data of interest is contributed. For example, as shown in FIG. 9, the user of interest drags the message 60a to the input field 62 with a cursor, whereby the user of interest can designate the data of interest indicated by the URL included in the message 60a.

In a case where the data of interest is designated by the user of interest, the notification destination specifying unit 52 transmits the URL of the data of interest (in a case where the data of interest is directly attached to the message 60a, the data ID of the data of interest) to the data management server 14. The processor 28 of the data management server 14 transmits a data name of the data of interest to the communication tool providing server 16 with reference to the data management DB 24. The message processing unit 50 displays the received data name (in the example of FIG. 9, “XX design material”) in the input field 62. “@” attached before the data name indicates that the message input to the input field 62 is a message with a notification instruction.

There is a case where the data of interest designated by the user of interest is not stored in the data management DB 24 of the data management server 14. For example, this case refers to a case where the user of interest contributes the URL of the data of interest by mistake or a case where the data of interest intended by the user of interest is already deleted from the data management DB 24. Alternatively, there may be a case where the user of interest does not have (loses) a right of access to the data of interest. In this case, the notification processing unit 54 notifies the user of interest that the user of interest does not have a right of access to the data of interest.

In the present exemplary embodiment, the user of interest may input the specifying condition for specifying the notification target user. The notification destination specifying unit 52 displays a specifying condition dialog 72 indicating a plurality of specifying conditions selectable by the user of interest in the input field 62. A plurality of specifying conditions selectable by the user of interest may be set in advance. For example, the notification destination specifying unit 52 displays the specifying condition dialog 72 in a case where the data name of the data of interest displayed in the input field 62 is pointed out (or clicked) by the user of interest with the cursor. In the example of FIG. 9, as the specifying condition, “registrant (user who registers the data of interest in the data management server 14)”, “updater (user who updates the data of interest)”, “reader (user who reads the data of interest)”, and “un-reader (user who does not read the data of interest, among the users who are participating in the channel of interest)” are selectable. Of course, the specifying condition is not limited thereto.

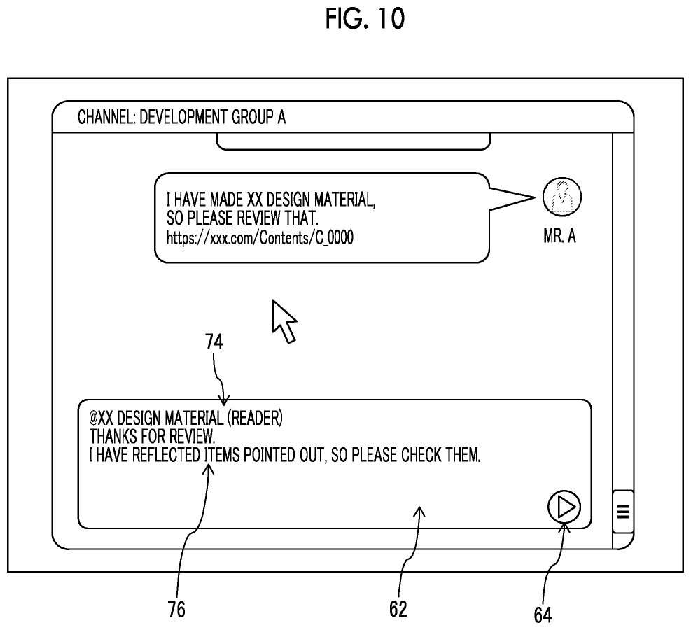

In a case where the user of interest selects any specifying condition in the specifying condition dialog 72, as shown in FIG. 10, the message processing unit 50 displays the selected specifying condition 74 in the input field 62.

In a case where the user of interest selects any specifying condition in the specifying condition dialog 72, the notification destination specifying unit 52 sends the URL or the data ID of the data of interest and information indicating the specifying condition selected by the user of interest to the data management server 14. The processor 28 of the data management server 14 specifies a user ID of a user who satisfies the specifying condition, based on at least one of the data management DB 24 or the operation history DB 26. For example, in a case where the specifying condition is “registrant”, the processor 28 specifies a user ID of a registrant of the data of interest with reference to the data management DB 24. In a case where the specifying condition is “updater”, the processor 28 specifies a user ID of a user who updates the data of interest, with reference to the operation history DB 26. In a case where the specifying condition is “reader” or “un-reader”, the processor 28 specifies a user ID of a user who reads the data of interest, with reference to the operation history DB 26. The processor 28 transmits the specified user ID to the communication tool providing server 16.

The notification destination specifying unit 52 specifies the notification target user from among users indicated by the user IDs received from the data management server 14, based on the channel DB 44. For example, in a case where the specifying condition is “registrant”, “updater”, and “reader”, the notification destination specifying unit 52 specifies the users who are participating in the channel of interest, among the users indicated by the user IDs received from the data management server 14 as the notification target user. In a case where the specifying condition is “un-reader”, the notification destination specifying unit 52 specifies users excluding the user IDs received from the data management server 14 from among a plurality of users who are participating in the channel of interest, as the notification target user.

In a case where the user of interest operates the transmission button 64 in a state in which information (in an example of FIG. 10, “ @XX design material (reader)”) regarding a message with a notification instruction is input to the input field 62, the message processing unit 50 contributes the message with a notification instruction to the channel of interest. Accordingly, the notification processing unit 54 performs notification to the specified notification target user. As shown in FIG. 10, the user of interest can also add the message with a notification instruction to a comment 76.

In a case where the message processing unit 50 contributes the message with a notification instruction to the channel of interest, and the notification processing unit 54 performs notification to the notification target user, the message processing unit 50 registers the message with a notification instruction and attribute information thereof in the message DB 46 (see FIG. 8). As the attribute information of the message with a notification instruction, information (for example, a URL indicating a storage location of data) for specifying notification target data (in this example, data of interest), and the specified notification target user are included.

In this way, in the present exemplary embodiment, in a case where the user of interest contributes information for specifying the data of interest to the channel of interest, notification may be performed only to users who are related to the data of interest.

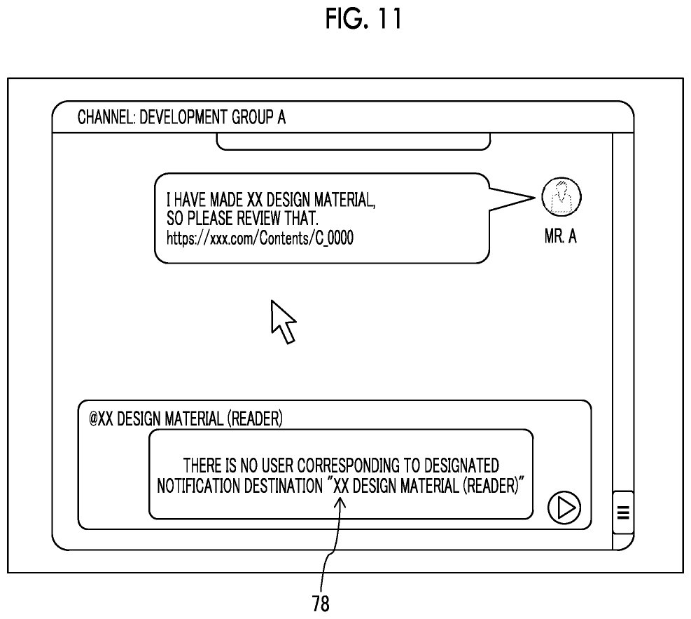

A case where there is no user who satisfies the specifying condition selected by the user of interest is considered. For example, this case refers to a case where there is no user who reads the data of interest, among the participants of the channel of interest in a case where the user of interest selects “reader” as the specifying condition. This is determined by confirming whether or not information indicating that there is no user who satisfies the specifying condition is transmitted from the data management server 14 to the communication tool providing server 16 or the notification destination specifying unit 52 confirms that there is no participant of the channel of interest among the users (the users who satisfy the specifying condition) indicated by the user IDs received from the data management server 14. In a case where there is no user who satisfies the specifying condition selected by the user of interest, the notification processing unit 54 notifies the user of interest that there is no user (that is, the notification target user) who satisfies the specifying condition. For example, as shown in FIG. 11, the notification processing unit 54 displays a notification target user absence dialog 78 indicating there is no notification target user, on the screen. An example of FIG. 11 is an example where notification is performed to the user of interest who contributes information (message 60a) for specifying the data of interest to the channel of interest.

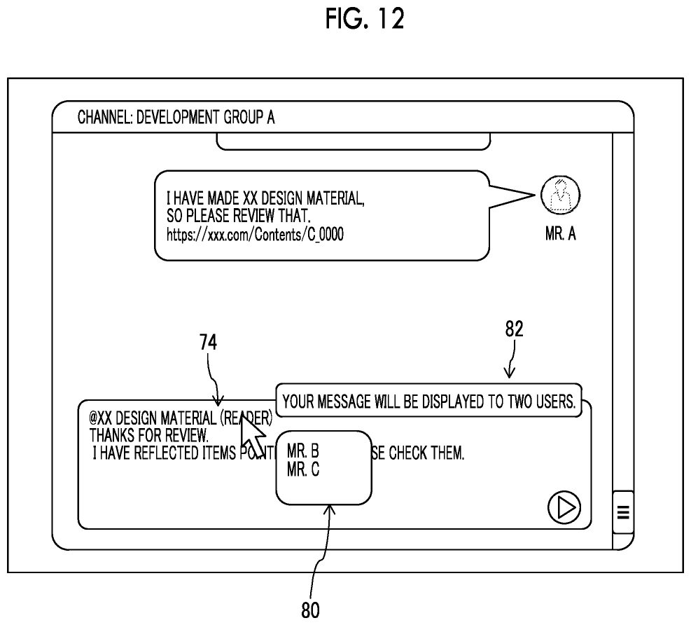

In the present exemplary embodiment, since the user of interest selects the notification target user under the specifying condition, the user of interest may not ascertain who the notification target user specifically is. Accordingly, the notification processing unit 54 may notify the user of interest of who the notification target user specifically is, for example, after the notification target user is specified. For example, as shown in FIG. 12, in a case where the specifying condition 74 displayed in the input field 62 is pointed out (clicked) by the user of interest with the cursor, the notification processing unit 54 displays a notification target user dialog 80 indicating the user name of the specified notification target user on the screen. The user name of the notification target user is specified based on the above-described user DB.

The notification processing unit 54 may notify the user of interest of the number of notification target users, for example, after the notification target users are specified. For example, as shown in FIG. 12, the notification processing unit 54 displays a number-of-people notification dialog 82 indicating the number of specified notification target users on the screen. In particular, there is a case where the number of notification target users is enormous while the user of interest fails to notice, in such a case, the notification to the notification target users may be improper. The user of interest confirms the number-of-people notification dialog 82, whereby the user of interest can also cancel notification in a case where the number of notification target users is large. The notification processing unit 54 may display the number-of-people notification dialog 82 only in a case where the number of notification target users is equal to or greater than a predetermined number of people.

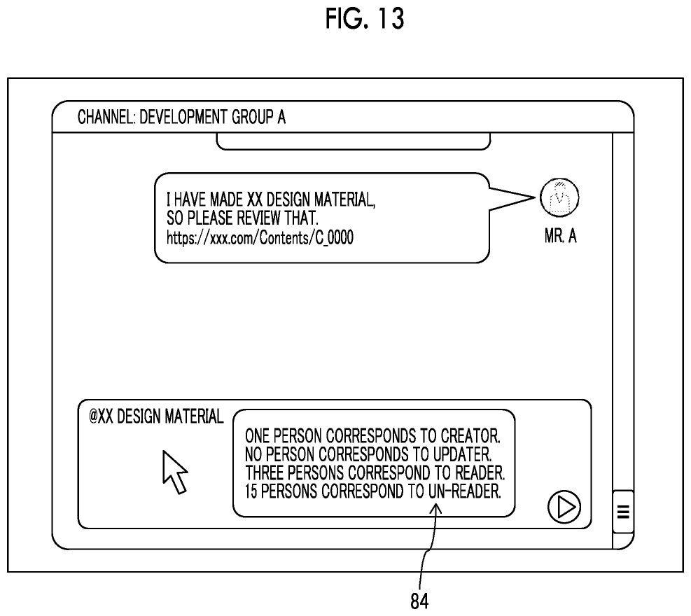

As shown in FIG. 13, the notification destination specifying unit 52 may specify the number of users who satisfy each specifying condition, prior to displaying the specifying condition dialog 72, and may display a specifying condition dialog 84 where the number of users who satisfy each specifying condition is displayed, along with each specifying condition.

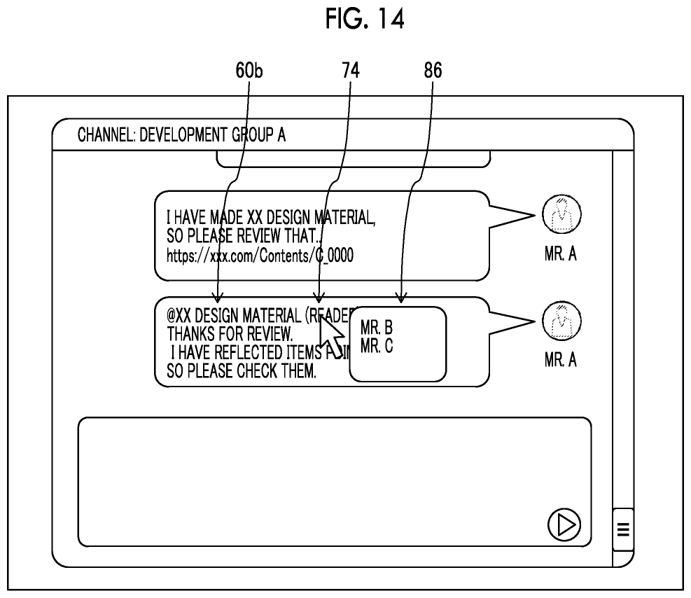

FIG. 14 is a diagram showing a state after a message 60b with a notification instruction is contributed to the channel of interest, that is, after notification is performed to the notification target users. Even in a case where the user of interest points out (clicks) the specifying condition 74 displayed in the contributed message 60b with a notification instruction with the cursor, the notification processing unit 54 may display a notification target user dialog 86 indicating the notification target users.

In this case, the notification processing unit 54 displays the notification target user dialog 86 based on the message DB 46 (see FIG. 8). That is, in a case where the user of interest selects the specifying condition 74 displayed in the contributed message 60b with a notification instruction, the notification processing unit 54 refers to the message DB 46 and specifies the notification target user registered as the attribute of the message 60b with a notification instruction. Then, the notification target user dialog 86 indicating the specified notification target users is displayed. Accordingly, for example, in a case where the specifying condition is “reader”, the users displayed in the notification target user dialog 86 are users to whom notification is actually performed by the contribution of the message 60b with a notification instruction (that is, users who reads the data of interest before the contribution of the message 60b with a notification instruction, and are not the readers of the data of interest at this moment. For example, in a case where the notification target user is “Mr. B” and “Mr. C”, even though “Mr. D” newly reads the data of interest after the contribution of the message 60b with a notification instruction (after the notification to “Mr. B” and “Mr. C”), in the notification target user dialog 86, only “Mr. B” and “Mr. C” are displayed and “Mr. D” is not displayed.

In FIGS. 9 to 14, after the message for specifying the data of interest is contributed to the channel of interest, data of interest is designated again, and then, the message with a notification instruction is contributed; however, the user of interest can also contribute the message with a notification instruction including information for specifying the data of interest to the channel of interest.

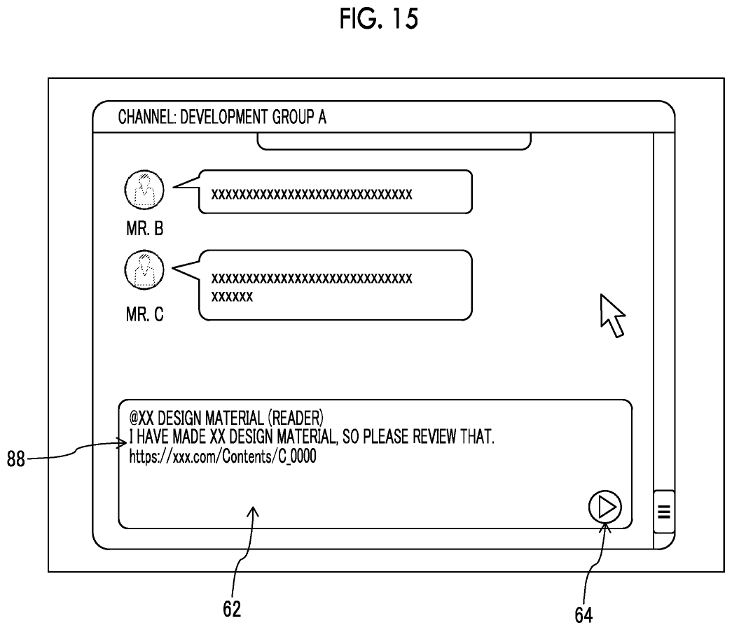

For example, as shown in FIG. 15, the user of interest inputs “@” to the input field 62, and then, input a comment 88 including the URL (may be attached to the data of interest) as information for specifying the data of interest to the input field 62. Then, in a case where the user of interest selects the specifying condition, the message processing unit 50 displays the selected specifying condition in the input field 62, and the notification destination specifying unit 52 transmits information indicating the specifying condition to the data management server 14 along with the URL (or the data ID) of the data of interest. Hereinafter, the notification target users are specified by the notification destination specifying unit 52 through the same processing as described above. In this case, before information for specifying the data of interest is contributed to the channel of interest, the notification target users are specified.

Then, in a case where the user of interest operates the transmission button 64, the message processing unit 50 contributes the message with a notification instruction including information for specifying the data of interest to the channel of interest. Accordingly, the notification processing unit 54 performs notification to the specified notification target user.

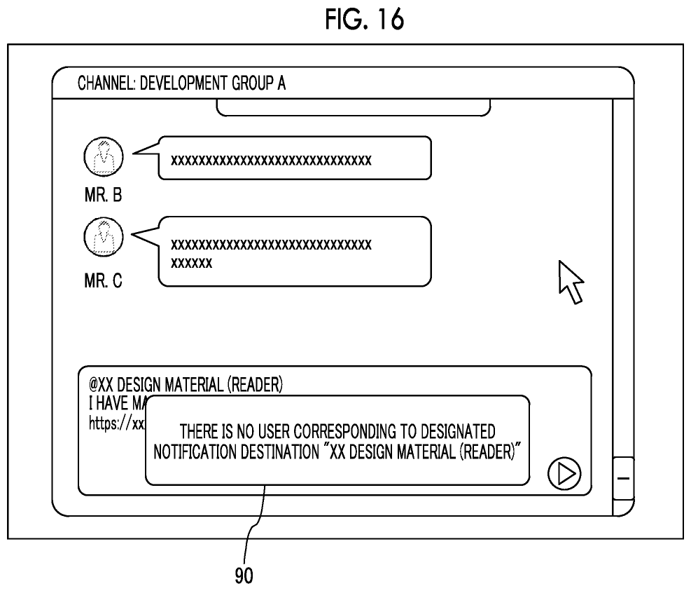

Even in a case where the message with a notification instruction including information for specifying the data of interest is input to the input field 62, in a case where there is no notification target user, the notification processing unit 54 notifies the user of interest that there is no notification target user. For example, as shown in FIG. 16, the notification processing unit 54 displays a notification target user absence dialog 90 indicating that there is no notification target user, on the screen. An example of FIG. 16 is an example where notification is performed to the user of interest who inputs information for specifying the data of interest to the input field 62 for the contribution to the channel of interest (in other words, the user of interest before the contribution of information for specifying the data of interest to the channel of interest).

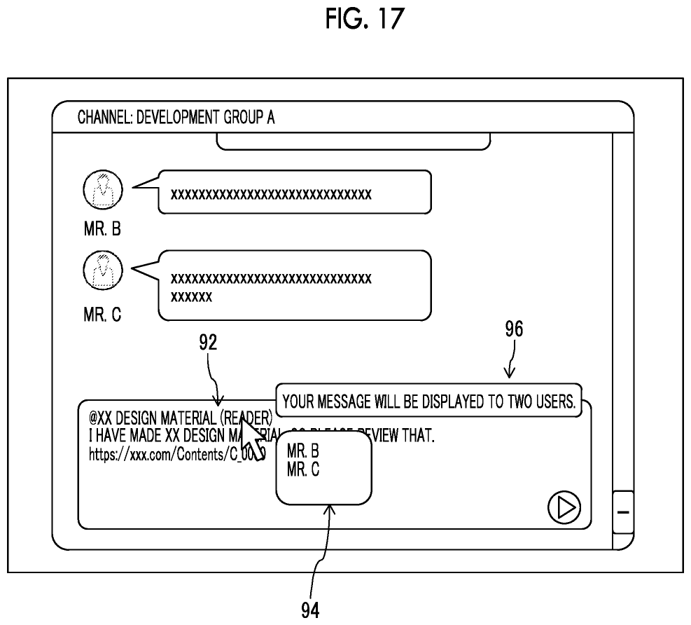

Even in this case, the notification processing unit 54 may notify the user of interest of who the notification target users specifically are, for example, after the notification target users are specified. For example, as shown in FIG. 17, in a case where the user of interest points out (clicks) a specifying condition 92 displayed in the input field 62, the notification processing unit 54 displays a notification target user dialog 94 indicating the user names of the specified notification target users on the screen.

The notification processing unit 54 may notify the user of interest of the number of notification target users, for example, after the notification target users are specified. For example, as shown in FIG. 17, the notification processing unit 54 displays a number-of-people notification dialog 96 indicating the number of specified notification target users on the screen. Even in this case, the notification processing unit 54 may display the number-of-people notification dialog 96 only in a case where the number of notification target users is equal to or greater than a predetermined number of people.

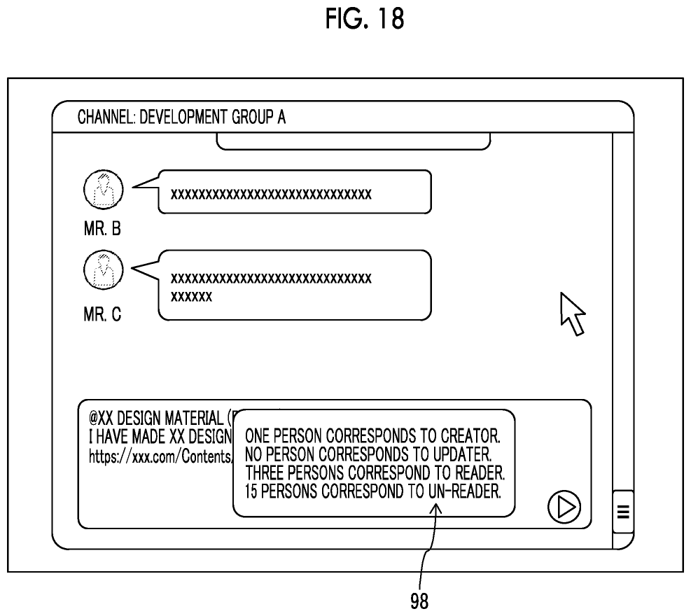

As shown in FIG. 18, the notification destination specifying unit 52 may specify the number of users who satisfy each specifying condition, and may display a specifying condition dialog 98 where the number of users who satisfy each specifying condition, along with each specifying condition.

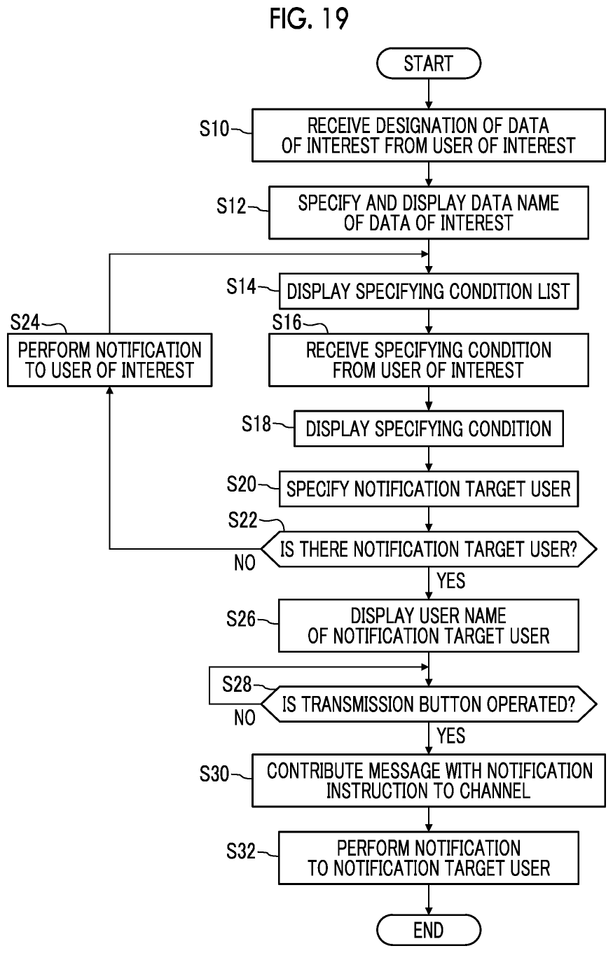

The outline of the configuration of the information processing system 10 according to the present exemplary embodiment as described above. Hereinafter, a flow of processing of the communication tool providing server 16 will be described following a flowchart shown in FIG. 19.

In Step S10, the message processing unit 50 displays the screen of the channel of interest on the display of the user terminal 12 of the user of interest, and receives the designation of the data of interest from the user of interest.

In Step S12, the notification destination specifying unit 52 displays the data name of the data of interest designated in Step S10 in the input field 62 (see FIG. 9 or 15).

In Step S14, the notification destination specifying unit 52 displays the specifying condition dialog 72 indicating a plurality of specifying conditions selectable by the user of interest on the screen (see FIG. 9).

In Step S16, the notification destination specifying unit 52 receives the specifying condition from the user of interest.

In Step S18, the message processing unit 50 displays the specifying condition 74 received in Step S16 in the input field 62 (see FIG. 10 or 15).

In Step S20, the notification destination specifying unit 52 specifies the notification target user based on the specifying condition received in Step S16.

In Step S22, the notification destination specifying unit 52 determines whether or not there is the notification target user. In a case where there is no notification target user, the process proceeds to Step S24. In Step S24, the notification processing unit 54 displays the notification target user absence dialog 78 or 90 (see FIG. 11 or 16) on the screen. Thereafter, the process returns to Step S14, and the notification destination specifying unit 52 displays the specifying condition dialog 72 again and receives the specifying condition from the user of interest again.

In Step S22, in a case where there is the notification target user, the process proceeds to Step S26. In Step S26, the notification processing unit 54 displays the notification target user dialog 80 or 94 (see FIG. 12 or 17) indicating the user name of the notification target user specified in Step S20 on the screen.

In Step S28, the message processing unit 50 waits until the transmission button 64 (see FIG. 10 or 15) is operated, and in a case where the transmission button 64 is operated, the process proceeds to Step S30.

In Step S30, the message processing unit 50 contributes the message with a notification instruction to the channel of interest.

In Step S32, the notification processing unit 54 performs notification to the notification target user specified in Step S20.

Although the exemplary embodiment according to the present invention will be described above, the present invention is not limited to the above-described embodiment, and various alterations can be made without departing from the gist of the present invention.

Supplementary Note

(((1)))

An information processing apparatus comprising:
a processor, wherein the processor is configured to:
   specify, in a case where information for specifying data of interest is contributed to a channel that is a place where a plurality of users are able to contribute information via a communication line or in a case where the information for specifying the data of interest is input for contribution to the channel, a notification target user based on data-related information including at least one of an operation history indicating a user who performs an operation with respect to the data of interest previously or attribute information indicating a user registered as an attribute of the data of interest; and
   perform notification to the notification target user after the information for specifying the data of interest is contributed.

(((2)))

The information processing apparatus according to (((1))), wherein the processor is configured to:
specify the notification target user from among a plurality of users who are able to read the information for specifying the data of interest contributed to the channel.

(((3)))

The information processing apparatus according to (((1))) or (((2))),
wherein the notification target user dynamically varies following accumulation of the operation history.

(((4)))

The information processing apparatus according to (((1))), wherein the processor is configured to:
receive a specifying condition of the notification target user regarding the data-related information from a user of interest who contributes the information for specifying the data of interest to the channel or inputs the information for specifying the data of interest to the information processing apparatus for contribution to the channel; and
specify a user who satisfies the specifying condition, as the notification target user.

(((5)))

The information processing apparatus according to (((4))), wherein the processor is configured to:
perform notification to the user of interest in a case where there is no user who satisfies the specifying condition.

(((6)))

The information processing apparatus according to (((1))), wherein the processor is configured to:
notify a user of interest who contributes the information for specifying the data of interest to the channel or inputs the information for specifying the data of interest to the information processing apparatus for contribution to the channel, of the specified notification target user.

(((7)))
An information processing program causing a computer to execute a process comprising:
specifying, in a case where information for specifying data of interest is contributed to a channel that is a place where a plurality of users are able to contribute information via a communication line or in a case where the information for specifying the data of interest is input for contribution to the channel, a notification target user based on data-related information including at least one of an operation history indicating a user who performs an operation with respect to the data of interest previously or attribute information indicating a user registered as an attribute of the data of interest; and
performing notification to the notification target user after the information for specifying the data of interest is contributed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor, wherein the processor is configured to:
specify, in a case where information for specifying data of interest is contributed to a channel that is a place where a plurality of users are able to contribute information via a communication line or in a case where the information for specifying the data of interest is input for contribution to the channel, a notification target user based on data-related information including at least one of an operation history indicating a user who performs an operation with respect to the data of interest previously or attribute information indicating a user registered as an attribute of the data of interest; and
perform notification to the notification target user after the information for specifying the data of interest is contributed.

2. The information processing apparatus according to claim 1, wherein the processor is configured to:
specify the notification target user from among a plurality of users who are able to read the information for specifying the data of interest contributed to the channel.

3. The information processing apparatus according to claim 1,
wherein the notification target user dynamically varies following accumulation of the operation history.

4. The information processing apparatus according to claim 2,
wherein the notification target user dynamically varies following accumulation of the operation history.

5. The information processing apparatus according to claim 1, wherein the processor is configured to:
receive a specifying condition of the notification target user regarding the data-related information from a user of interest who contributes the information for specifying the data of interest to the channel or inputs the information for specifying the data of interest to the information processing apparatus for contribution to the channel; and
specify a user who satisfies the specifying condition, as the notification target user.

6. The information processing apparatus according to claim 5, wherein the processor is configured to:
perform notification to the user of interest in a case where there is no user who satisfies the specifying condition.

7. The information processing apparatus according to claim 1, wherein the processor is configured to:
notify a user of interest who contributes the information for specifying the data of interest to the channel or inputs the information for specifying the data of interest to the information processing apparatus for contribution to the channel, of the specified notification target user.

8. A non-transitory computer readable medium storing an information processing program causing a computer to execute a process comprising:
specifying, in a case where information for specifying data of interest is contributed to a channel that is a place where a plurality of users are able to contribute information via a communication line or in a case where the information for specifying the data of interest is input for contribution to the channel, a notification target user based on data-related information including at least one of an operation history indicating a user who performs an operation with respect to the data of interest previously or attribute information indicating a user registered as an attribute of the data of interest; and
performing notification to the notification target user after the information for specifying the data of interest is contributed.

9. An information processing method comprising:
specifying, in a case where information for specifying data of interest is contributed to a channel that is a place where a plurality of users are able to contribute information via a communication line or in a case where the information for specifying the data of interest is input for contribution to the channel, a notification target user based on data-related information including at least one of an operation history indicating a user who performs an operation with respect to the data of interest previously or attribute information indicating a user registered as an attribute of the data of interest; and
performing notification to the notification target user after the information for specifying the data of interest is contributed.
